(19) United States
(12) Patent Application Publication
(10) Pub. No.: US 2026/0078057 A1
(43) Pub. Date: Mar. 19, 2026

(54) USE OF AMORPHOUS SILICA REAGENT PRODUCED FROM SERPENTINE IN CONCRETE PREPARATION

(71) Applicants: ALLIANCE MAGNESIUM, Danville (CA); SOCPRA SCIENCES ET GENIE S.E.C., Sherbrooke (CA)

(72) Inventors: Joël FOURNIER, Carignan (CA); Laury Gauthier, St-Apollinaire (CA); Ablam ZIDOL, Sherbrooke (CA); Arezki TAGNIT-HAMOU, Sherbrooke (CA)

(21) Appl. No.: 19/381,477

(22) Filed: Nov. 6, 2025

Related U.S. Application Data
(63) Continuation of application No. 17/758,648.
(60) Provisional application No. 62/986,911, filed on Mar. 9, 2020.

(51) Int. Cl. C04B 28/04; C04B 14/06; C04B 18/14; C04B 20/02; C04B 22/06; C04B 103/30; C04B 103/32; C04B 111/00

(52) U.S. Cl. CPC C04B 28/04; C04B 14/06; C04B 18/146; C04B 20/023; C04B 22/066; C04B 2103/302; C04B 2103/304; C04B 2103/32; C04B 2111/00103

(57) ABSTRACT

It is disclosed the use of amorphous silica reagent produced from serpentine as pozzolane additive material, and more particularly a concrete mixture, such as high performance and ultra-high performance concrete, comprising a hydraulic binder; sand; aggregates, chemical admixture, mineral admixture as silica fume and an amorphous silica reagent (AmSR), wherein the AmSR is admixed for example with General Use Portland Cement and provides synergistic effect when combined with silica fume.

### CROSS-REFERENCE TO RELATED APPLICATION

This is a continuation of U.S. application Ser. No. 17/758,648, which is a U.S. National Phase of International Application No. PCT/CA2021/050303, filed on Mar. 8, 2021, and claiming priority of U.S. Provisional Application No. 62/986,911 filed Mar. 9, 2020, the content of which are hereby incorporated by reference in their entirety.

### TECHNICAL FIELD

It is provided the use of amorphous silica reagent as a pozzolane additive in concrete preparation.

### BACKGROUND

Supplementary cementitious materials (SCM) have been used in the concrete industry since several decades. While the initial incentive to the use of SCMs was primarily based on bare economical grounds, today's concrete-technology community's interest in these materials is further driven by the targeted enhancement in concrete properties (from eco-efficiency perspectives and performance-wise). Such trend is justified by the well-established energy and pollution-intensive cement manufacturing process consuming annually 2-3% of the global primary energy use and releasing about 5% of the global human activity CO₂ emissions.

Prevailing SCMs in the Canadian concrete industry include: fly ash (FA) from coal-fired thermal power stations, ground granulated blast furnace slag (GGBFS) from iron and steel industry, and silica fume (SF) from the silicon industry. These SCMs are standardized for use in concrete and are commonly used at 5-50% replacement of Portland cement (PC), with few attempts at higher rates up to 60%.

The incorporation of SCMs can considerably enhance the performance of concrete products. For example, it can contribute in protecting concrete against aggressive agents (de-icing salts and sulphates) and steel rebars against potential corrosion and result into a more durable concrete. However, in some regions, common SCMs (SF, FA, and GGBFS) are limited and importing them from elsewhere increases their cost and the invoice in green house gaze (GHG) emissions per cubic meter of concrete. On top of that, the quality of SCMs is important, but it can vary. Poor-quality fly ash for example can have a negative effect on concrete.

It is still desirable to find new pozzolane additives with low cost and reliable quality for improving mechanical properties and extending the life span of concrete, with environmental benefits.

### SUMMARY

One aim of the present description is to provide a concrete mixture comprising a hydraulic binder; sand; aggregates; a cementitious material; and an amorphous silica reagent (AmSR) comprising SiO₂ and active MgO.

In an embodiment, the AmSR comprises more than 40% of SiO₂.

In another embodiment, the AmSR comprises at least 60% of SiO₂.

In an embodiment, the AmSR comprises at least 10% of active MgO.

In another embodiment, the AmSR comprises at least 18% of active MgO.

In a further embodiment, the AmSR is a serpentine derived AmSR.

In another embodiment, the AmSR consists of particles of less than 45 μm.

In a further embodiment, the AmSR consists of particles with an average size between 5 and 30 μm.

In another embodiment, the concrete mixture comprises Quartz sand.

In a further embodiment, the cementitious material is silica fume, granulated blast furnace slag, metakaolin, natural pozzolana, fly ash, calcined shale, limestone, recycling glass residue, or a combination thereof.

In an embodiment, the concrete mixture comprises silica fume.

In another embodiment, the hydraulic binder is Portland Cement (PC).

In another embodiment, the concrete admixture described herein further comprises a high-range water reducer (HRWRA).

In a particular embodiment, the AmSR comprised in the concrete admixture described herein is produced by crushing serpentine tailing; leaching the serpentine in an acid solution producing a slurry with undissolved silica comprising a solid and liquid fraction; and separating the solid and liquid fractions of the slurry recuperating the AmSR.

In an embodiment, the leaching is conducted at a temperature between 60 to 125° C.

In a further embodiment, the mixture is a cement mortar, conventional concrete, High performance concrete (HPC), a grout or a self-consolidating concrete (SCC).

In an embodiment, the mixture is a CEM type I, II, III, IV or V cement.

In an embodiment, the mixture further comprises a superplasticizer, a water reducer agent, an air entrainment agent, or a combination thereof.

In a further embodiment, it is provided that the encompassed mixture is a high performance concrete (HPC) or a ultra-high performance concrete (UHPC).

In an embodiment, the UHPC comprises up to 20% of AmSR.

### In Another Embodiment, the HPC Comprises:

GU cement;
silica fume (SF);
AmSR;
water;
sand;
aggregates;
an entraining admixture; and
a superplasticizer.

### In a Further Embodiment, the UHPC Comprises:

water;
silica fume;
cement;
quartz powder;
sand; and
AmSR.

In an embodiment, the concrete mixture comprises:

| | |
|---|---|
| Cement (kg/m³) | 353-415 |
| Silica fume (SF) (kg/m³) | 4-40 |
| AmSR (kg/m³) | 5-45 |
| Water (kg/m³) | 90-175 |
| Sand 0-5 mm (kg/m³) | 558-910 |
| Aggregates 5-14 mm (kg/m³) | 1050-1120 |
| Entraining admixture ml/100 kg | 125-300 |
| Superplasticizer (l/m³) | 1.2-4.0. |

In a further embodiment, the concrete mixture comprises:

| | |
|---|---|
| Cement (kg/m³) | 610-1080 |
| Silica fume (SF) (kg/m³) | 50-334 |
| AmSR (kg/m³) | 5-200 |
| Water (kg/m³) | 126-261 |
| quartz powder (kg/m³) | 0-410 |
| quartz sand (kg/m³) | 490-1390 |
| Superplasticizer (kg/m³) | 6-71. |

### BRIEF DESCRIPTION OF THE DRAWINGS

Reference will now be made to the accompanying drawings.

FIG. 1 illustrates a flow chart of AmSR production.

FIG. 2 illustrates a flow chart of AmSR production with active MgO.

FIG. 3 illustrates the rheological behavior of self-consolidating concrete (SCC) mixtures described herein.

FIG. 4 illustrates the compressive strength of SCC mixtures described herein.

FIG. 5 illustrates the tensile splitting strength of SCC mixtures described herein.

FIG. 6 illustrates a histogram showing the chloride-ions penetration of SCC mixtures described herein.

FIG. 7 illustrates a histogram showing the electrical resistivity of SCC mixtures described herein.

FIG. 8 illustrates flow time of grout with w/b=0.40 at 60 min.

FIG. 9 illustrates the modulus of elasticity of concrete mixes ((a): w/b=0.45; (b): w/b=0.40; and (c): w/b=0.35).

FIG. 10 illustrates the scaling resistance of concrete tested.

FIG. 11 illustrates the expansion of mortar bars due to sulphate attack.

FIG. 12 illustrates chloride ion permeability of conventional concrete with different w/b ratio.

FIG. 13 illustrates the electrical resistivity of conventional concrete with different w/b ratio.

FIG. 14 illustrates compressive strength of ternary concrete with w/b=0.40.

FIG. 15 illustrates chloride ion permeability of ternary concrete with w/b=0.40.

FIG. 16 illustrates the electrical resistivity of ternary concrete with w/b=0.40.

FIG. 17 illustrates the scaling resistance of HPC concrete tested.

FIG. 18 illustrates the expansion of mortar bars due to sulphate attack on HPC concrete mixture.

FIG. 19 illustrates the compressive strength of UHPC.

FIG. 20 illustrates the relative heat of hydration of cementitious system including AmSR.

FIG. 21 illustrates the cumulative heat of hydration of cementitious system including AmSR.

### DETAILED DESCRIPTION

In accordance with the present description, there is provided amorphous silica reagent (AmSR) extracted from serpentine as a pozzolane additive material. AmSR has a large specific surface area (SSA) and high content in silicates which enhances reactivity, effective filler effect and pozzolanic activity.

Pozzolanic C—S—Hs densifies and reduces permeability of cement paste. Pozzolane additions containing MgO can also be used to form additional silicate hydrates (M-S—Hs).

Supplementary silicate hydrates produced by pozzolanic reaction give a finer porosity by a capillary effect within the initially formed hydrates. They generate isolated islands between the hydrated or partially hydrated grains. This increases the tortuosity of the cement matrix and hence, decreases its permeability.

The proposed pozzolane additive herein is amorphous silica reagent (AmSR), which significantly improves the concrete's mechanical properties, durability performance and environmental issues. Magnesium silicate ores can be used to produce pozzolane additive. For example, serpentine is a family of mineral silicates and contains approximately 40 percent SiO₂ and 38 percent MgO. Large quantities are available in North America and around the world from the former asbestos industry. Over the years, mountains of tailings have accumulated and have created a major environmental issue for the former and actual asbestos production country. These deposits represent an excellent natural resource, easily available. The leaching of serpentine with an acid allows the soluble elements to pass in a solution leaving behind a solid residual silica with an amorphous attribute.

For example, AmSR can be produced directly from serpentine tailing residues. Alternatively, AmSR can be a by-product generated by the production of magnesium or derived magnesium products. Near the cities of Asbestos and Thetford Mines, QC (Canada), there are approximately 800 million tons of ready-to-process stored tailings. Serpentine tailing consist mainly of lizardite (Mg₃Si₂O₅(OH)₄) with other minor components such as magnetite (Fe₃O₄) and awaruite (Ni₈Fe₃).

The leaching process produces an amorphous silica with a high content in SiO₂, such as more than 60%. To valorize and remedy to serpentine tailing residues storage, it is proposed a mean to produce a pozzolane additive material aimed to partially replace Portland cement in concrete.

As described in Canadian Patent No. 2,954,938, WO2016/176772 and WO2016/077925 the content of which are incorporated herein in their entirety, and as illustrated in FIG. 1, in a particular embodiment, the process of producing AmSR from serpentine comprises at first the crushing of serpentine tailing 10. A lizardite concentration step 12 of removing magnetic material is optional. The serpentine is leached 14 with an inorganic acid solution during a given period of time which allows dissolving the magnesium and other elements like iron and nickel. In an embodiment, the inorganic acid can be hydrochloric acid (HCl), sulfuric acid (H₂SO₄) or nitric acid (HNO₃) or a mixture thereof. The silica remains totally undissolved after leaching. The leaching is conducted at a temperature between 60 to 125° C., at for example at 80° C. The slurry then undergoes a solid-liquid separation 16 by suitable filtration equipment, such as belt filter or filter press to recuperate amorphous silica and salts 18 characterised by a very large surface area from the solution containing magnesium, iron and nickel 20. The silica is washed 22 with water to eliminate salts impregnated and dried 24 at a temperature between 100 to 200° C. to remove the physically adsorbed water on the particle surfaces. Silica can be submitted to a heat treatment 26 at a temperature below 800° C. to conserve amorphous form. Hydroxyl groups (Si—OH) are partially or totally removed from the silica surface depending on the temperature and heating time. The reduction of specific surface caused by new grouping (Si—O—Si) is low. Silica can be milled 28 to reduce grain sizes according to the initial size distribution of serpentine particles (FIG. 1). The AmSR 30 produced contains more than 60% SiO₂. The solution 20 can be purified to remove impurities, for example iron, and recover magnesium, nickel and cobalt in the form of different minerals, for examples MgCl₂, Ni(OH)₂, Co(OH)₂.

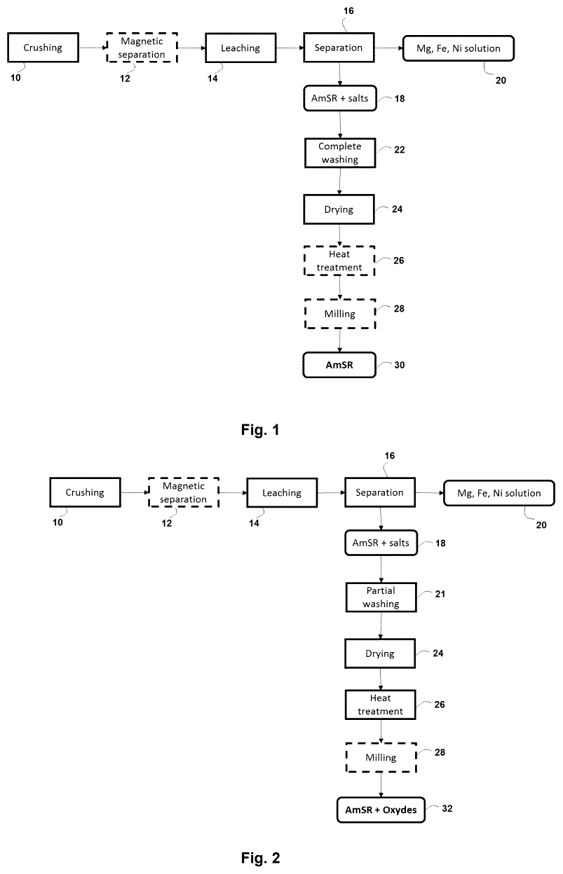

The amorphous silica can be partially washed 21 to conserve a part of salts, mainly composed of magnesium for example magnesium chloride (MgCl₂). The silica is dried and submitted to a heat treatment at a temperature between 55° and 800° C. (FIG. 2). Impregnated salts are converted to oxide form such magnesium oxide. This AmSR 32 contains more than 60% SiO₂ and between 0.1 and 10% active magnesium oxide (MgO). This magnesium oxide is qualified as active by the formation of magnesium silicate hydrates (M-S—Hs) in the cement.

Alternatively, serpentine can be leached with an organic acid solution such as oxalic acid (C₂H₂O₄). After a given period of time, the slurry then undergoes a separation step to recuperate the mixture of amorphous silica and magnesium oxalate (MgCl₂O₄·2H₂O) under solid form. The mixing of solids is first washed with water then dried between 10° and 200° C. The mixture is submitted to a heat treatment at a temperature between 550 and 800° C. to convert magnesium oxalate in an oxide form. This process allows to produce AmSR containing more than 40% SiO₂ and more than 40% active MgO. Magnesium oxide is qualified as active by the formation of magnesium silicate hydrates (M-S—Hs). AmSR with considerable level content of SiO₂ and MgO can be qualified as hydraulic binders.

Considering its high content in SiO₂ under an orphous attribute, it is described herein a mean to use AmSR in concrete as a pozzolane additive. Thus, in a perspective of reducing the environmental impact of Portland cement production, it is provided a mean to use an alternative product. It is thus described the use of amorphous silica reagent (AmSR), such as a by-product of magnesium production or a by-product of derived magnesium compounds production, as partial replacement of Portland cement in concrete.

The influence of incorporating AmSR in partial replacement of Portland cement (PC) by up to 30% on fresh properties, mechanical properties and durability aspects is described herein on cement mortars and different types of concrete including conventional concrete, self-consolidating concrete (SCC), high performance concrete (HPC) and Ultra high performance concrete (UHPC).

A mortar/concrete mix is understood to be a mixture of dry components of a mortar/concrete composition. The main dry components of the mixtures are understood to be a binder (cement, mineral additions), water, an aggregate, that is understood to be at least fine aggregate (sand), and coarse aggregate (gravel) and optionally, chemicals admixture.

As encompassed herein, types of cement include CEM I up to and including CEM V, which are characterized by a smaller or larger content of Portland cement and slag or fly ash. There is basically two types of cements used in construction, mainly common cements and special cements. Special cements include for example sulphate-resistant cement, seawater-resistant cement, cement with low heat of hydration, white cements. Common cement are generally identified by the abbreviation CEM followed by an indication of the characterizing additive used such as blast-furnace slag, silica fume, natural pozzolana, natural calcined pozzolana, siliceous fly ash, calcareous fly ash, calcined shale and limestone. Particularly, CEM I is known as Portland cement which contains a maximum of 5% of other or secondary materials. CEM II are known as all kind of hybrids of Portland cement with for example slate, fly ash, slag with a minimum 65% Portland cement. CEM III is also known as blast furnace/Portland cement mixture in 3 classes: A, B and C, whereby CEM III/A contains at least (40%) and CEM III/C contains at most (90%) slag. CEM IV are cement of Pozzolana cement varieties. CEM V are composite cements, with mixtures of Portland cement, slag and Pozzolana.

A mortar/concrete composition is understood to be the mortar/concrete mixture with water providing a working mortar or a working concrete that hardens to a mortar and a concrete, respectively.

A mortar composition is further understood as a thick pasty mixture of water, generally a fine aggregate, mineral additions and hydraulic binder (cement) that upon hardening is used to hold building materials together.

A concrete composition is understood to be similar to a mortar composition including coarse aggregates.

As intended herein, a hydraulic binder is understood to be the portion of the concrete or mortar composition that hardens upon addition of water with a hydration reaction. The terms “hydraulic binder” and “cement” are used herein as synonyms and include but are not limited to: Portland cement, high alumina cement, lime cement, kiln dust cement, high phosphate cement, and ground granulated blast furnace slag cement. A chemical reaction occurs upon addition of water to change the mineral structure of the binder.

Self-consolidating concrete or self-compacting concrete, commonly abbreviated to SCC, is known as a concrete mix which has a low yield stress, high deformability, good segregation resistance and moderate viscosity. The segregation resistance prevents separation of particles in the mix and the moderate viscosity is necessary to ensure uniform suspension of solid particles during transportation, placement, without external compaction, and thereafter until the concrete sets.

The incorporation of AmSR in concrete decreases the workability of concrete mixtures; increases the yield stress and the plastic viscosity; enhances cohesion and reduces segregation; alters the hydration kinetic; improves DH which reflect on improve mechanical performance; enhances compressive strength; reduces chloride-ions penetrability; increases the electrical resistivity and induces acceptable resistance to freezing and thawing.

High performance concrete (HPC) are cementitious concrete, material strength and durability significantly higher than normal concrete material. At the present time, high-performance concrete in developed countries usually refers to concrete with 28-day compressive strength beyond 70-80 MPa, durability factor above 80%, and w/c below 0.35. It is made with good quality aggregates, high cement content, and a high dosage of both silica fume (5-15 wt. % of cement) and superplasticizer (5-15 I·m⁻³). Sometimes other pozzolanic materials are also used.

With high cement content, the use of superplasticizers and silica fume and the need for more stringent quality control, the unit cost of high-performance concrete can exceed that of normal concrete by 30-100%, thus resulting in a higher material cost. High-performance concrete can also be produced with lightweight aggregates. However, the aggregate needs to be very carefully chosen to make sure it is sufficiently strong. By saturating their pores with water before mixing, these aggregates can act as internal reservoirs that supply water to ensure continued cement hydration and prevent autogenous shrinkage due to self-desiccation.

Ultra-high performance concrete (UHPC) is a newly developed concrete characterized by being a steel fiber-reinforced cement composite material with compressive strengths in excess of 150 MPa, up to and possibly exceeding 250 MPa. UHPC is also characterized by its constituent material make-up: typically fine-grained sand, silica fume, small steel fibers, and special blends of high-strength Portland cement, without the presence of large aggregate.

It is provided the incorporation AmSR in HPC and UHPC. AmSR is a very fine powder that is used to fill granular voids between particles of cement and silica fume (SF).

The density of AmSR is 2.45 and its Blaine fineness and BET fineness are respectively 4955 m²/kg and 72030 m²/kg. The density of silica fume is 2.22 and its BET fineness is 17490 m² kg. The density of the cement is 3.15 and its Blaine fineness is 424 m²/kg. In terms of order of magnitude, the Blaine fineness of AmSR is more than 10 times that of GU cement and its BET fineness is more than 4 times that of silica fume. This reflects a relatively high fineness of the AmSR. The particle size distribution analysis show a continuous and relatively spread distribution of the particles of cement and AmSR. This very high fineness of AmSR is not reflected in particle size, and it is due to the high porosity of AmSR particles. The particle size curve of the silica fume is different and illustrates a continuous and relatively tight distribution. The particle size curve of AmSR is between those of cement and silica fume, suggesting that AmSR particles are likely to adequately fill the intergranular voids between cement particles and silica fume, and thus densify more the cement matrix.

In terms of its chemical and physical properties, as exemplified herein, AmSR differs from glass powder for example, especially in terms of its composition. AmSR has an average approximate content of SiO₂ of 58.8% compared to 72% for glass powder. In addition, AmSR has a high MgO content (around 18.6%) unlike glass powder which contains a negligible amount. Their density is relatively similar (AmsR: 2.45 kg/m³ compared to 2.5 kg/m³ for glass powder). Also, AmSR is characterized by a Blaine fineness greater than that of glass powder (4955 kg/m³ for AmSR compared to 382 kg/m³ for glass powder).

AmSR is characterized by a much higher pozzolanicity than glass. When tested, the pozzolanicity of the powder glass is 85% at 28 days compared to 121% for AmSR. The high pozzolanic activity of AmSR promotes the development of mechanical properties and transformation of the cement matrix. Therefore, the higher pozzolanic effect of AmSR contributes significantly to improving mechanical properties and the durability of concrete, especially when AmSR is combined with silica fume.

It is demonstrated that there is a good synergy between amorphous silica reagent (AmSR) and silica fume in the development of compressive strength of HPC. Electrical resistivity measurements determine HPC concrete permeability classes similar to those obtained by the rapid penetration test of chloride ions according to ASTM C1202. The electrical resistivity measured was in the same class of potential durability for all HPC concretes. There is an increase in the electrical resistivity of HPC concrete made with AmSR with age, synonymous with the evolution of hydration and a significant reduction in the permeability of concrete which results in an improvement in the durability of HPC.

When the total deformations and isothermal deformations due to the endogenous shrinkage of the HPC were studied, HPC with 4% AmSR resulted in a total and isothermal deformations that are almost similar to control HPC (Contr.). HPC with 8% AmSR showed a total strain and isothermal deformation which is about half of that of the control HPC or HPC made with 4% AmSR.

Systematic swelling of all the concretes was observed and after 7 days of hydration, the recorded total or isothermal deformations decrease with the increase of the rate of incorporation of the AmSR in addition into the concretes. Indeed, the total or isothermal strain recorded in the HPC with 8% AmSR represented less than half of that recorded for the HPC control (Tem). This difference is due to the initial swelling and not to the development of the microstructure and microporosity. These observations suggest that the AmSR-based HPCs develop relatively less endogenous shrinkage and thus, correlatively, a reduction in the risks of significant cracking related to this phenomenon.

It is provided ultra-high performance concrete (UHPC) comprising AmSR as described herein. UHPCs made with AmSR changed color slightly, from dark gray to yellowish. This can be interesting for architectural concretes. The density of UHPCs comprising AmSR is practically similar to comparative control UHPC. The air content in UHPC decreased with the addition of AmSR in the mixtures as obtained without vibration of concrete. These concretes are manufactured without addition of air entrained and the decrease of the air content makes it possible to have better mechanical properties and less bubbling on the surface.

In an embodiment, it is provided a HPC mixture comprising:

| | |
|---|---|
| Cement (kg/m³) | 353-415 |
| Silica fume (SF) (kg/m³) | 4-40 |
| AmSR (kg/m³) | 5-45 |
| Water (kg/m³) | 90-175 |
| Sand 0-5 mm (kg/m³) | 558-910 |
| Aggregates 5-14 mm (kg/m³) | 1050-1120 |
| Air Entraining admixture ml/100 kg | 125-300 |
| Superplasticizer (l/m³) | 1.2-4.0 |

In an embodiment, it is provided a UHPC mixture comprising:

| | |
|---|---|
| Cement (kg/m³) | 610-1080 |
| Silica fume (SF) (kg/m³) | 50-334 |
| AmSR (kg/m³) | 5-200 |
| Water (kg/m³) | 126-261 |
| quartz powder (kg/m³) | 0-410 |
| quartz sand (kg/m³) | 490-1390 |
| Superplasticizer (kg/m³) | 6-71 |

As provided herein, the properties of AmSR, such as its granulometry and its finesse, allow to optimize judiciously the granular skeleton of the concrete composition in order to fill the intergranular voids with particles of size between 8 and 9 μm. Thus, the distribution of AmSR particles promotes a complementarity with that of the particles of silica fume to maintain good compactness of the granular skeleton. Therefore, the properties of fresh concrete as well as the rheo-mechanical properties and durability of HPC for example, including a combination of silica fume and AmSR, are not deteriorated while allowing reduce manufacturing costs compared to mixtures that include only silica fume. It follows that it is provided a mean to reduce effectively the costs of preparing a concrete mixture comprising silica fume by the demonstration of a synergistic effect observed in compositions of concrete including AmSR and a minimal amount of silica fume.

Calorimetry is another indicator of the synergistic effect between AmSR and silica fume. It is described that when measuring the evolution of the hydration heat and the hydration heat accumulated at different ratios of silica fume and AmSR, the combination of silica fume and AmSR is associated with higher compressive strengths and reduced setting time of concrete.

In addition, compared to glass powder which is a component widely used in cement mixtures, it is more advantageous to use AmSR. Firstly, no grinding is necessary with AmSR and results in fewer undesirable phenomena due to the lower alkali content. It is known that the alkalis in the cement can react with the reactive aggregates and thus cause cracking of concrete and a significant reduction in their durability. As a result it is always a goal to reduce the amount of alkali in the composition of a concrete. More particularly, it is preferable to use cements including less than 0.6% alkali to be usable when there are reactive aggregates. Glass powder has an alkali content of 13% compared to 0.26% for AmSR, which can advantageously reduce possible reactions with aggregates reagents.

### Example I

### AmSR Characterization

The table 1 below present chemical composition (CC) and specific surface area (SSA) of a typical serpentine tailing and for two samples of AmSR. CC were obtained by X-ray fluorescence analysis with lost in ignition at 1000° C. SSA were determined with the Brunauer, Emmett, and Teller (BET) method.

TABLE 1
Chemical composition and specific surface
area of serpentine tailing and AmSR

| Materials | Serpentine | AmSR 1 | AmSR 2 |
|---|---|---|---|
| Raw material used for | | Raw | Non magnetic |
| leaching | | serpentine | serpentine |
| | | <500 microns | <75 microns |
| AmSR Post-processing | | Complete wasing | Partial wasing |
| | | Drying at 200° C. | Drying at 550° C. |
| Chemical analysis (%) | | | |
| SiO2 | 39.0 | 77.6 | 84.4 |
| Al2O3 | 1.86 | 1.87 | 1.32 |
| Fe2O3 | 8.52 | 1.52 | 1.24 |
| MgO | 36.2 | 7.05 | 5.64 |
| CaO | 1.08 | 1.71 | 0.84 |
| Na2O | 0.14 | 0.22 | 0.18 |
| K2O | 0.27 | 0.32 | 0.14 |
| TiO2 | 0.06 | 0.09 | 0.08 |
| MnO | 0.12 | 0.06 | 0.03 |
| Cr2O3 | 0.38 | 0.44 | 0.62 |
| P2O5 | 0.03 | <0.01 | <0.01 |
| LOI 1000° C. | 12.4 | 8.88 | 4.99 |
| Sum | 100.1 | 99.8 | 99.5 |
| S_{BET} (m²/g) | 7.2 | 363 | 339 |

AmSR 1 was produced by leaching raw serpentine tailing with hydrochloric acid. AmSR was abundantly washed with fresh water to remove salts until it contained less than 0.1% in chloride content. The silica was dried at 200° C. The SiO₂ content is 77.6% and the SSA is 363 m²/g. By comparison with serpentine, the amorphous content increased by fifty times.

The second AmSR or AmSR 2 was obtained by leaching non-magnetic fraction of serpentine, such as with less iron. The same acid was used. The AmSR was partially washed before drying at 105° C. AmSR was submitted to heating treatment at 550° C. The content in SiO₂ is 84.4% with around 2% of active magnesium oxide. The other part comes from residual serpentine.

In a further analysis, the chemical composition shown in Table 2 demonstrates a relatively high magnesium content in AmSR. Although the AmSR material is treated, it contains a magnesium content of the order of ten (10) times that of GU cement. Silica is the main chemical element in content of the order of 59%. AmSR contains low levels of alkalis and lime.

TABLE 2
Chemical composition of AmSR, SF and GU cement

| | Material | | |
|---|---|---|---|
| | AmSR | Silica | Cement |
| Elements | (%) | Fume (%) | GU (%) |
| Na₂O | 0.15 | 0.1 | 0.18 |
| MgO | 18.59 | 0.2 | 1.81 |
| Al₂O₃ | 1.73 | 0.3 | 4.7 |
| SiO₂ | 58.79 | 94.4 | 20.43 |
| P₂O₅ | 0.01 | 0.1 | |
| SO₃ | 0.00 | | 3.53 |
| K₂O | 0.17 | 0.5 | 0.95 |
| CaO | 0.67 | 0.7 | 62.39 |
| TiO₂ | 0.04 | | |
| Cr₂O₃ | 0.44 | | |
| Mn₃O₄ | 0.07 | | |
| Fe₂O₃ | 4.57 | 0.1 | 2.97 |
| Co₃O₄ | — | | |
| NiO | 0.11 | | |
| CuO | 0.02 | | |
| ZnO | 0.01 | 0.3 | |
| SrO | 0 | | |
| ZrO₂ | 0 | | |
| BaO | 0.02 | | |
| PbO | 0.01 | | |
| HfO₂ | 0.01 | | |
| LOI % | — | | |
| PAF | 14.6 | 2.58 | 2.51 |
| Na₂O_{éq} | 0.261 | 0.43 | 0.8013 |
| Total | 100.01 | 99.28 | 99.47 |

### Example II

### Incorporation of AmSR in Cementitious System and Conventional Concrete

AmSR and a Canadian PC of general use (GU) similar to Type I US cement (ASTMC150) were used to prepare cement pastes, mortars, and concrete. The AmSR was incorporated in partial replacement of PC at rates between 0% and 30%.

Sample AmSR used was produced by leaching raw serpentine tailing <1000 microns with hydrochloric acid. AmSR was washed with fresh water to remove salts until it contained less than 0.1% in chloride content. The silica was dried at 100° C. and milled to reduce grain size.

The density of powders was determined using a helium pycnometer in compliance with ASTM C118 guidelines. The size distributions were determined using a laser grain-size analyzer where the analysis was carried out through a laser diffraction method by dispersing the powders in ethanol. The LOI was measured via the Mie scattering model using thermogravimetric analysis.

AmSR has 64.3% in SiO₂ content. The higher content in silicates is an indicator for an enhanced pozzolanic activity while the increased surface area suggests an enhanced reactivity and an effective filler effect. This is further supported by the particle size distribution where approximately 95% of AmSR particles are smaller than 45 μm and have an average size of 8.4 μm as compared to 89% of GU cement particle below 45 μm and with an average size of 16.2 μm. The AmSR also exhibits higher Blaine fineness, about ten times that of GU cement. This result consolidates the amorphous form of AmSR and further indicates the reactivity of this powder.

SCC mixtures with AmSR exhibited improved stability characteristics. The stability of SCC mixtures with 10 and 20% AmSR were evaluated by the visual stability index (VSI). While the reference mixture had a VSI of 1 the mixture is stable with no evidence of segregation, but an observable slight bleeding. For both mixes, a VSI of 0 indicates highly stable mixtures with no evidence of segregation or bleeding.

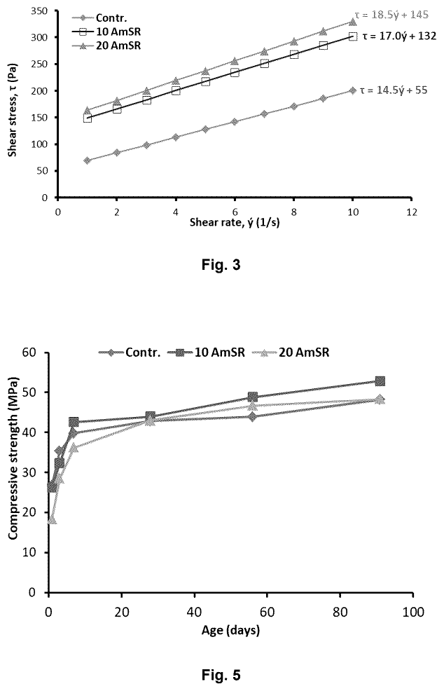

The improved stability in SCC mixtures with AmSR increased their cohesion and reduced their propensity for segregation. This is also evidenced by the rheological measurements (FIG. 3) where the addition of AmSR as encompassed herein increased both the yield stress (τ₀) and the plastic viscosity (μₚₗ), but within acceptable limits for SCC (50≤τ₀≤200 Pa); 20≤μₚₗ≤100 Pa·s).

Since the compressive strength represents a major parameter in the mechanical properties of cement-based systems, the effect of incorporating AmSR on mechanical properties was first evaluated for the compressive strength of cement mortars with AmSR in replacement of PC at rates of 0 to 30 wt. % for a curing time up to 182 days. While at early ages (1 day) all mixtures with AmSR had lower compressive strength than that of the reference mixture, higher compressive strength with AmSR was obtained at later ages (≥7 days). This is an archetypical behavior of SCMs where the impact is more pronounced with time evolution.

Results further indicate that while the incorporation of AmSR at all replacement levels generally showed higher compressive strength than that of the reference mixture, it should be noted that the compressive strength gain was optimum at 20% AmSR. At this rate, a significant enhancement in compressive strength from 21 to 35%, relative to the reference, was obtained for the different curing ages. This shows that while the effect of AmSR can take place even at low incorporation rates, such 10 and 15%, the 20% incorporation rate may be considered adequate for combined filler and pozzolanic effects.

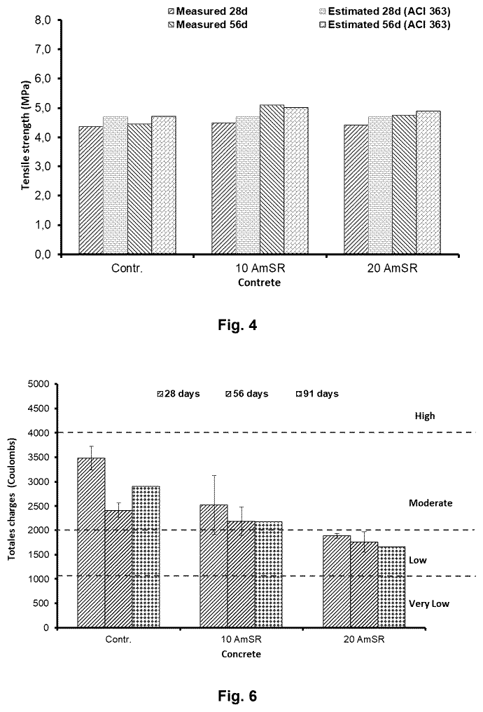

The evolution of the compressive strength of SCC mixture over time, as illustrated in FIG. 4, indicates again that at early ages (<7 days), mixtures with AmSR had lower compressive strength than that of the reference. Strength parity between the PC mixture and the blended mixtures started to emerge beginning from 7 days of curing. At 7 days for instance, the compressive strength of the mixture with 10% AmSR had already exceeded that of the reference mixture by 5%. By the 28th day, both mixtures with 10 and 20% AmSR had compressive strengths (44 and 43 MPa, respectively) comparable to that of the reference mixture (42 MPa). By the 56th day, the mixtures with 10% and 20% AmSR had 12% and 7%, respectively, higher compressive strength than that of the reference. The SCC mixture with 10% AmSR showed higher compressive strength than that of the mixture with 20% AmSR—in an opposite trend to the observations made in cement mortars—due to the fact that the latter had slightly higher air content (8.6%) than the former (8.1%). Should the SCC mixture with 10% AmSR be considered as a representative mixture for its enhanced mechanical properties, it can be observed that while the strength gain (beyond 7 days) in the reference mixture was 8% and 10% at 28 and 56 days, respectively; this gain corresponds to 5% and 16% in the mixture with 10% AmSR. The increasing trend of compressive strength gain at later ages (56 days) in the mixtures with AmSR is an indicator for the enhanced filler/pozzolanic effect endowed by AmSR.

The evaluation of the tensile splitting strength at 28 and 56 days (FIG. 5) shows that the tensile capacity follows a trend similar to that of the compressive strength where SCC mixtures with 10 and 20% AmSR had, respectively, 14 and 7% higher tensile splitting strength relative to that of the reference mixture. A comparison between measured tensile capacities and estimated ones based on ACI 363 (based on the compressive strength) shows high consistence.

FIG. 6 presents the results of the chloride-ions penetrability in coulombs (C) after 28, 56 and 91 days of curing. According to the ASTM C1202, the chloride-ions penetrability values are ranked as high (>4000C), moderate (2000-4000C), low (1000-2000C) and very low (<1000C). While reference SCC mixture exhibited penetrability in high levels of the moderate range, the mixture with 10% AmSR had penetrability at lower levels of the moderate range. The mixture with 20% AmSR, however, showed much attenuated chloride-ions penetrability. Thus, the incorporation of 10 and 20% AmSR reduced the chloride-ions penetrability of the reference SCC.

The reduction in the chloride-ions penetrability over time, particularly in the blended systems, can be ascribed to the time-dependent pozzolanic reaction where the secondary C—S—H generated by the reaction of AmSR with the CH from PC hydration gradually refines matrix pores, densifies the microstructures, and increases the tortuosity of the pore network. This can also be cross-linked to the enhancement in the mechanical properties, where an inversely-proportional relationship can be drawn between the compressive strength gain history and the chloride-ions penetrability. As such, penetrability decreases as the curing age increases due the matrix densification by the formed hydrates. Penetrability also decreases with the addition of AmSR due to further matrix densification by the pozzolanic C—S—H as mentioned above.

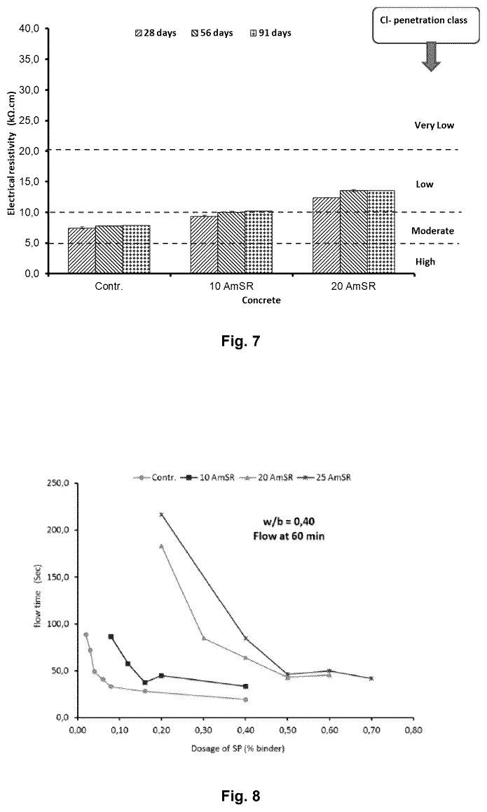

Another durability aspect described herein was the electrical resistivity. The electrical resistivity of concrete is linked to the corrosion's likelihood of reinforcing bars because corrosion itself is an electro-chemical process where the rate of flow of ions between the anode and cathode (and thus the rate of corrosion), is affected by the resistivity of concrete. As such, higher resistivity values imply less likelihood of corrosion occurrence while lower values of resistivity imply that corrosion occurrence is high. FIG. 7 depicts the results of the electrical resistivity of SCC mixtures at 28, 56 and 91 days. Durability levels come from guide 2004 produced by the Association Française de Génie Civil (AFGC). Both mixtures with 10 and 20% AmSR showed increased resistivity values (low likelihood of reinforcement corrosion). This indicates the potential of AmSR for enhancing the durability of concrete structures.

Further, the assessment of the resistance to freezing and thawing showed that all SCC mixtures maintained excellent resistance after 300 freezing and thawing cycles. With a durability index of 100% for the reference SCC, the mixtures with 10 and 20% AmSR had durability indices of 98 and 102%, respectively, which exceed the 60% threshold set by ASTM C 666.

The Marsh Cone test is used to determine the saturation dosage of superplasticizer for a grout incorporating different rates of AmSR. It consists of measuring the flow time in seconds of a given grout mixture by varying its dosage in superplasticizer (SP) until the saturation dosage is reached. The saturation dosage is the dosage beyond which any increase in SP no longer leads to a fluidity gain. FIG. 8 show the results of flow times at 60 min after the water-binder contact. The mixtures presented are control (0% AmSR), grout containing 10, 20 and 25% of AmSR as replacement of cement. An increased in the SP dosage leads to a decrease in the flow time. The saturation dosage of the grout increases with the rate of incorporation of the AmSR, illustrating an increase in the demand of chemical admixtures by the AmSR. This increase in the SP dosage results from the very high fineness of AmSR.

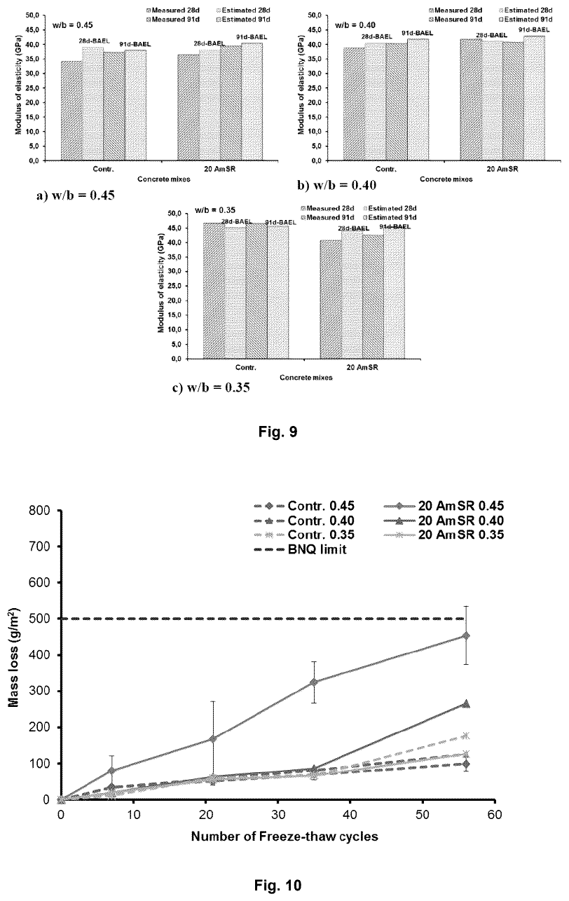

FIG. 9a-c respectively for water-binder ratios of 0.45, 0.40 and 0.35, show the modulus of elasticity of the concretes determined according to ASTM C469. The Modulus of elasticity was also estimated by BAEL formula, E_{c}=1100*f'_{cd}^{1/3}×10⁻³ where E_{c} (GPa) is modulus of elasticity and f'_{cd} (MPa) is compressive strength of concrete.

For each concrete, the measured values at 28 and 91 days were similar to the predicted values, suggesting a good estimation of the modulus of elasticity of the concretes by the BAEL formula. Regardless the w/b ratio, the modulus of elasticity of the concrete containing 20% of AmSR was similar to that of the control concretes. By reducing the w/b ratio by 0.05, an increase in the modulus of elasticity of at least 5.0 GPa was observed in the control concrete or in the concrete containing 20% of AmSR.

The scaling resistance of the concrete tested herein determined in accordance to BNQ 2621-900 is shown on FIG. 10. According to this standard, the resistance to scaling of a concrete was expressed by the loss of mass after 56 cycles of freezing-thawing in the presence of de-icing salt. Regardless of the w/b ratio, the concrete containing AmSR exhibits slightly greater scaling mass losses than the control concrete. In the presence of the AmSR, an increase of loss of mass due to the scaling, with the increase of the w/b ratio was systematically observed. Through these results, it can be seen that all the concretes have an average mass loss for the two concrete specimens with size of 75×255×255 mm after 56 cycles of freezing-thawing was less than 500 g/m², which is the maximum limit of mass loss recommended by BNQ 2621-900. According to this standard, all the tested concretes develop good resistance against scaling.

It is thus described herein the effectiveness and viability of AmSR as a pozzolane additive. The incorporation of AmSR in SCC decreased the workability of SCC mixtures and increased the yield stress and the plastic viscosity of the reference SCC by up to 2.7 and 1.4 times, respectively. This lead to a low increased demand in HRWRA.

Nonetheless, AmSR mixtures exhibited an enhanced cohesion and a reduced segregation due to the stability imparted by AmSR. AmSR altered the hydration kinetics and improved the DH of plain systems by up to 20%, owing to the combined filler and pozzolanic effects. The enhanced DH was reflected on the mechanical performance. Lower compressive strength was recorded before 7 days, but higher strength was maintained later. The compressive strength gain in cement mortars was optimum at 20% AmSR where a significant enhancement (up to 35%) relative to the reference was obtained. In SCC mixtures, strength parity started from the 7th day and enhancement up to 12% relative to the reference was obtained at 56 days. Similar trend was observed in the tensile splitting strength where AmSR improved the capacity of the reference SCC by up to 14%.

The assessment of durability aspects of SCC indicated that the incorporation of AmSR lowered the chloride-ions penetrability of the plain SCC by up to 47% (and maintained it within the low range); increased the electrical resistivity by approximately 10% (and maintained it within the low range, reflecting the reduced likelihood of reinforcement corrosion); and imparted acceptable resistance to freezing and thawing (a resistance index of up to 102%).

FIG. 11 shows sulfate resistance by evaluating expansion according to ASTM C1012 on mortar bars. All mortars incorporating AmSR show less expansion compared to control mortars. Approximately, mortars incorporating AmSR show ⅓ of the level of expansion measured for control mortars. Accordingly, incorporation of AmSR in mortar allows to control expansion and thus increase resistance to sulfate. By reducing the calcium concentration, the addition of AmSR increases resistance of cement to sulfate and sea water. Its pozzolanic action on sulfate resistance is based on its ability to react with Ca(OH)₂ which is no longer available to react with sulfates.

Table 3 below presents binary concrete mix used herein:

TABLE 3
Binary concrete mix

| | | | Binary concrete mix proportion per m³ | | | | | |
|---|---|---|---|---|---|---|---|---|
| | | | 0.55- | 0.55-20 | 0.45- | 0.45-20 | 0.40- | 0.40-20 |
| Materials | Unity | Density | Contr. | AmSR | Contr. | AmSR | Contr. | AmSR |
| Cement type GU | kg | 3.15 | 300 | 240 | 375 | 300 | 400 | 320 |
| Amorphous silica | kg | 2.45 | 0 | 60 | 0 | 75 | 0 | 80 |
| reagent (AmSR) | | | | | | | | |
| Water | kg | 1.0 | 165.0 | 165.0 | 168.8 | 168.8 | 160.0 | 160.0 |
| Sand 0-5 mm | kg | 2.67 | 762 | 748 | 689 | 671 | 691 | 672 |
| Aggregates 5-14 | kg | 2.71 | 856 | 856 | 856 | 856 | 856 | 856 |
| mm | | | | | | | | |
| Aggregates 10- | kg | 2.73 | 214 | 214 | 214 | 214 | 214 | 214 |
| 20 mm | | | | | | | | |
| Air Entrainment | ml/100 kg | 1.00 | 25 | 30 | 48 | 44 | 36 | 25 |
| (Airex-L) | | | | | | | | |
| Water Reducer | ml/100 kg | 1.15 | 200 | 200 | 250 | 250 | 250 | 250 |
| Agent (Eucon DX) | | | | | | | | |
| Superplasticizer | L/m3 | 1.07 | 0.00 | 0.90 | 0.00 | 0.86 | 0.62 | 1.50 |
| (Plastol 6400) | | | | | | | | |

The compressive strength of conventional binary concretes was determined according to ASTM C39. There is a systematic increase in the resistance with the age of the concretes, resulting from the evolution of the cement hydration reaction and the pozzolanic activity of the AmSR. Concretes containing 20% AmSR have significantly higher compressive strengths of more than 5 MPa compared to 28 or 91 days of control concrete. This trend reflects a major contribution of the AmSR to the development of concrete resistances. It emerges mainly from the observations that the AmSR has a significant potential to contribute to the development of compressive strength of conventional binary concretes.

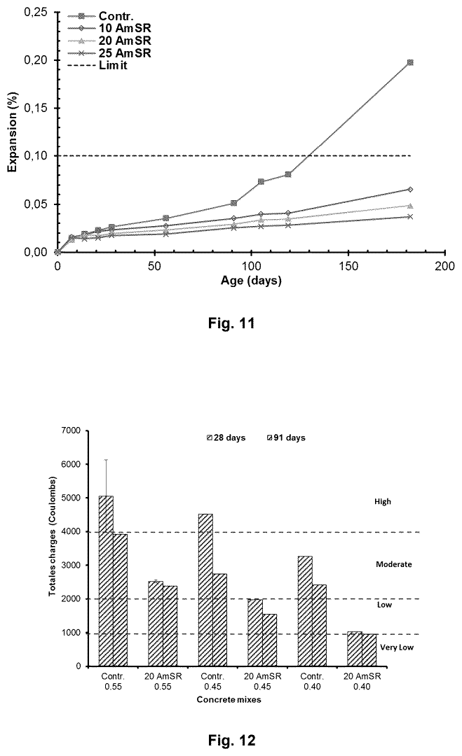

The chloride ion permeability test of concretes is carried out in accordance with ASTM C1202. FIG. 12 shows the chloride ion permeability at 28 and 91 days of conventional binary concretes with w/b ratios of 0.55 to 0.40. Whether than the concrete having the ratio w/b=0.55 or 0.45 or 0.40, the concrete containing 20% of the AmSR has a permeability which is half that of the control concrete. For example, the chloride ion permeability of the 0.45 control is in the high to moderate permeability class at 28 and 91 days, respectively. On the other hand, that of concrete containing 20% AmSR and having w/b=0.45 is in the low permeability class, either at 28 or 91 days. There is then a considerable reduction in the permeability of the concrete in the presence of AmSR. Indeed, the permeability of concrete containing 20% AmSR is half that of the control concrete, illustrating that AmSR reduces by half the permeability to chloride ions of concrete. This significant reduction in permeability is due to the filler effect and the pozzolanic reaction of AmSR, which favors densification of the matrix and increased pore segmentation. A similar trend is observed in the series of concretes having w/b=0.55 or 0.40. The chloride ion permeability of 20% AmSR-containing concretes with w/b=0.40 is half that of the control concrete with w/b=0.40. For this ratio w/b=0.40, the permeability of the control concrete is moderate while that of the concrete containing 20% AmSR. Regardless of the w/b ratio, the AmSR containing concrete definitely has a much lower permeability than the control concrete, at least halved. The considerable reduction of the permeability by the AmSR comparable to its filler effect and its pozzolanic reaction would undoubtedly contribute to the improvement of the resistance of the concrete to the penetration of the potentially aggressive external agents and correlatively a significant improvement of the durability of the concrete and especially of resistance to corrosion induced by chloride ions.

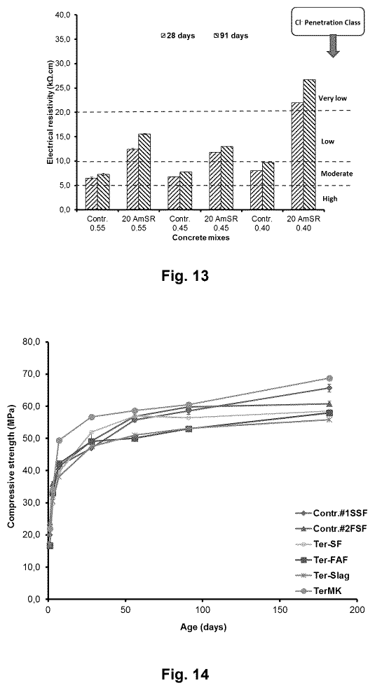

The apparent electrical resistivity of the concretes measured using the RCON™ electrical resistivity apparatus, which uses an alternating current, is presented in FIG. 13. The resistivity increases markedly with the incorporation of AmSR, reflecting an improvement in the permeability of the concretes. These results of electrical resistivity illustrate a considerable reduction in the permeability of concretes in the presence of AmSR synonymous with an improvement of the durability of the concrete by the AmSR.

The combination of AmSR with GU cement as described herein in various cementitious systems such as grout, mortar and concrete results in a concrete with a relatively high fineness; presents a continuous particle size distribution; slightly increases the demand for chemical admixtures in concrete; rapidly develops compressive strengths; develops strong pozzolanic index activity; significantly reduces the chloride-ion penetration; and significantly increases the electrical resistivity of cementitious matrices. Therefore, the results provided herein based on the performance of the amorphous silica reagent (AmSR) in cementitious matrices demonstrate its beneficial use in building materials.

It is further demonstrated that binary concretes incorporating AmSR develop higher compressive strengths than control concrete from 28 days, demonstrating the significant contribution of AmSR to improving mechanical properties. It densifies the cementitious matrix, significantly reduces the permeability of the concrete and correlatively improves its resistance to the penetration of aggressive potential external agents and its durability. For concretes containing AmSR exposed to scaling these concretes must be formulated with an w/b ratio significantly lower than 0.45.

Formulation of ternary concrete mix tested herein are listed in Table 4 below:

TABLE 4
Ternary concrete formulations

| | | Ternary concrete mix proportion per m³ | | | | | | |
|---|---|---|---|---|---|---|---|---|
| | | | Contr#1- | Contr#2- | | | | |
| | | | SSF | FSF | Ter-SF | Ter-FFA | Ter-S | Ter-MK |
| | | | 22S | 20F | 20AmSR | 15AmSR | 15AmSR | 15AmSR |
| Materials | Unit | Density | 5SF* | 5SF* | 5SF | 10FFA | 12S | 10MK |
| Cement GU | kg | 3.15 | 0 | 0 | 300 | 300 | 292 | 300 |
| Cement Tercem3000 | kg | 2.89 | 400 | 0 | 0 | 0 | 0 | 0 |
| (Gub-S/SF) | | | | | | | | |
| Cement TerC3 (Gub- | kg | 2.89 | 0 | 400 | 0 | 0 | 0 | 0 |
| F/SF) | | | | | | | | |
| Amorphous silica | kg | 2.45 | 0 | 0 | 80 | 60 | 60 | 60 |
| reagent (AmSR) | | | | | | | | |
| Silica Fume | kg | 2.22 | 0 | 0 | 20 | 0 | 0 | 0 |
| Class F Fly Ash | kg | 2.63 | 0 | 0 | 0 | 40 | 0 | 0 |
| Slag | kg | 2.89 | 0 | 0 | 0 | 0 | 48 | 0 |
| Metakaolin | kg | 2.51 | 0 | 0 | 0 | 0 | 0 | 40 |
| Water | kg | 1.0 | 160 | 160 | 160 | 160 | 160 | 160 |
| Sand 0-5 mm abs 0.86 | kg | 2.67 | 660 | 660 | 664 | 670 | 673 | 668 |
| Aggregates 5-14 mm | kg | 2.71 | 856 | 856 | 856 | 856 | 856 | 856 |
| abs 0.47 | | | | | | | | |
| Aggregates 10-20 mm | kg | 2.73 | 214 | 214 | 214 | 214 | 214 | 214 |
| abs 0.34 | | | | | | | | |
| Air entrainment agent | ml/100 kg | 1.00 | 39 | 47 | 39 | 22 | 33 | 44 |
| (Airex-L) | | | | | | | | |
| Water reducer (Eucon | ml/100 kg | 1.15 | 250 | 250 | 250 | 250 | 250 | 250 |
| DX) | | | | | | | | |
| Superplasticizer (Plastol | L/m3 | 1.09 | 0.72 | 0.83 | 2.17 | 1.44 | 1.67 | 1.99 |
| 6400) | | | | | | | | |

Ternary concretes identified as Contr #1 et Contr #2 are concrete formulated with commercial ternary concretes Tercem 3000® and TerC3®. Tercem 3000® contains 5% silica fume and 22% of granulated blast furnace slag, produced by Lafarge®. TerC3® comprises 5% silica fume and 20% fly ash, produced by Holcim®. All other ternary concretes were formulated with 15 or 20% AmSR in combination with other components normally used in the preparation of concretes. Explicitly, combinations prepared were: 20% AmSR with 8% silica fume (Ter-SF); 15% AmSR with 10% fly ash (Ter-FFA); 15% AmSR with 12% granulated blast furnace slag (Ter-S); and 15% AmSR with 10% metakaolin (Ter-MK).

The compressive strength of the ternary concretes is presented in FIG. 14. At a young age, the ternary concretes containing AmSR, except the one containing the metakaolin, have significantly lower strengths than the two control ternary concretes, but at the later ages they develop resistances almost similar to those of control concretes. The ternary concrete containing AmSR and metakaolin develops resistances much higher than those of the controls. Its resistance at 28 days is of the order of 9.6 MPa and 7.5 MPa higher than those of the respective control ternaries Contr #1 and Contr #2. This rapid development of resistance in the presence of metakaolin is linked to its high fineness which would promote a significant filler effect and formation of nucleation sites fairly fast and considerable. The AmSR has good synergy with other cement additions. It can suitably be used to develop ternary systems for particular applications.

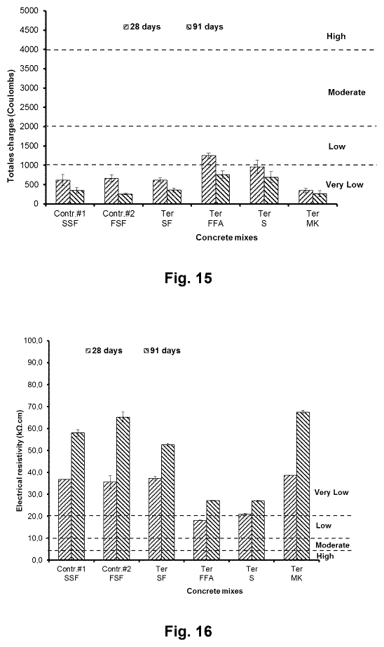

The rapid penetration test for chloride ions to estimate the permeability of concrete was carried out in accordance with ASTM C1202. FIG. 15 shows the total charge through each concrete measured during the test. These results show that all ternary concretes have low or very low permeability, synonymous with good resistance to the penetration of potentially aggressive external agents, suggesting a good improvement in the durability of these concretes. The considerable reduction in the permeability of these concretes is attributable to the effects of the cementitious additions which densify the cementitious paste and transform the porous network.

FIG. 16 shows the apparent electrical resistivity of ternary concretes. The electrical resistivity results illustrate permeability classes perfectly identical to those observed with the rapid penetration test of chloride ions according to ASTM C1202 standard on the same concretes. At 28 days, the electrical resistivity oscillates between the low and very low permeability classes whereas at 91 days, the electrical resistivity remains in the class of very low permeability for all these ternary concretes. Ternary concretes based on AmSR perform as well as control ternary concretes based on marketed cements. The low permeability of ternary concretes results from the combined effect of the cementitious additions used in their composition on the considerable transformation of the characteristics of the porous network.

Drying shrinkage for the ternary concretes were measured according to the ASTM C 157 standard. AmSR exhibit drying shrinkage of the same order of magnitude as those of the control ternary concretes not containing AmSR. In sum, AmSR does not amplify drying shrinkage of concretes.

The ternary concretes formulated have multiple advantages such as higher compressive strength at 28 days, low permeability, low dimensional variation due to drying shrinkage and increased durability. Ternary systems appear to have increased resistance to alkali-silica reactions and would be more resistant to sulphate attack. The ternary mixtures based on AmSR and either silica fume or metakaolin can control the expansion due to the alkali reaction. These ternary mixtures are more effective in controlling the expansion due to the alkali-silica reaction than the binary mixtures. After 6 months of sulphate exposure, mixtures incorporating different levels of AmSR show sulphate attack expansions well below the limit of the standard, thus contributing significantly to the reduction of expansion due to sulphate attack.

### Example III

### High Performance Concrete

Some specific compositions of the high performance concretes (HPC) are presented in Table 5. The concretes are HPC with or without silica fume (SF). In the concrete nomenclature, the concrete identified Tem, is a control HPC containing a level of 8% SF, that identified 4% AmSR is a HPC containing in addition, a rate of 4% of AmSR and 4% of SF and the concrete identified 8% AmSR, is a silica-free HPC containing in addition 8% of AmSR.

TABLE 5
High performance concrete formulations

| | Composition of HPC w/b = 0.32 | | | | |
|---|---|---|---|---|---|
| | | | | 4% | 8% |
| Materials | Unit | Density | Tem | AmSR | AmSR |
| GU cement | kg | 3.15 | 414 | 414 | 414 |
| Silica fume (SF) | kg | 2.22 | 36 | 18 | 0 |
| AmSR | kg | 2.45 | 0 | 18 | 36 |
| Water | kg | 1.00 | 144 | 144 | 144 |
| Sand 0-5 mm | kg | 2.67 | 677 | 680 | 681 |
| Aggregates 5-14 mm | kg | 2.71 | 1070 | 1070 | 1070 |
| Entraining admixture | ml/100 kg | 1.01 | 105 | 119 | 239 |
| (Eucon Air Mac 12) | | | | | |
| Superplasticizer | L/m³ | 1.09 | 3.50 | 3.50 | 3.80 |
| (Viscocrete 6100) | | | | | |

As seen in Table 6, for the compressive strengths for each concrete, there is a systematic increase in resistance with age, resulting from the evolution of the hydration reaction of the cement and the pozzolanic activity of the AmSR. Whether at 1 or 7 days, compressive strengths of high performance concrete containing only silica fume and those of HPC containing both AmSR and silica fume (FS) are equivalent. These results illustrate a good synergy between amorphous silica powder and silica fume in the development of compressive strength. Therefore as provided herein, it is advantageous to partially replace silica fume in concrete mixture, notably in HPC, by AmSR for its advantages in terms of manufacturing cost and availability of AmSR in comparison to silica fume. These benefits are achieved without significant reduction in compressive strength. As provided herein, it is advantageous to keep a certain amount of silica fume in the composition due to the synergistic effect observed between AmSR and silica fume, in particular by making it possible to reduce the resistance losses in compression.

TABLE 6
Compressive strengths of tested High performance concrete

| | Compressive strength (MPa) | | | | | |
|---|---|---|---|---|---|---|
| | Contr. | | 4% AmSR | | 8% AmSR | |
| Age (jours) | Moy. | σ | Moy. | σ | Moy. | σ |
| 1 | 40.7 | 0.5 | 39.1 | 0.7 | 40.7 | 1.0 |
| 7 | 62.1 | — | 62.0 | — | 56.5 | 0.5 |
| 14 | 67.5 | 0.2 | 66.3 | 1.7 | 57.8 | 0.1 |
| 28 | 76.1 | 1.2 | 74.2 | 0.3 | 65.2 | 0.7 |
| 91 | 80.9 | 1.9 | 78.1 | | 67.5 | 0.5 |

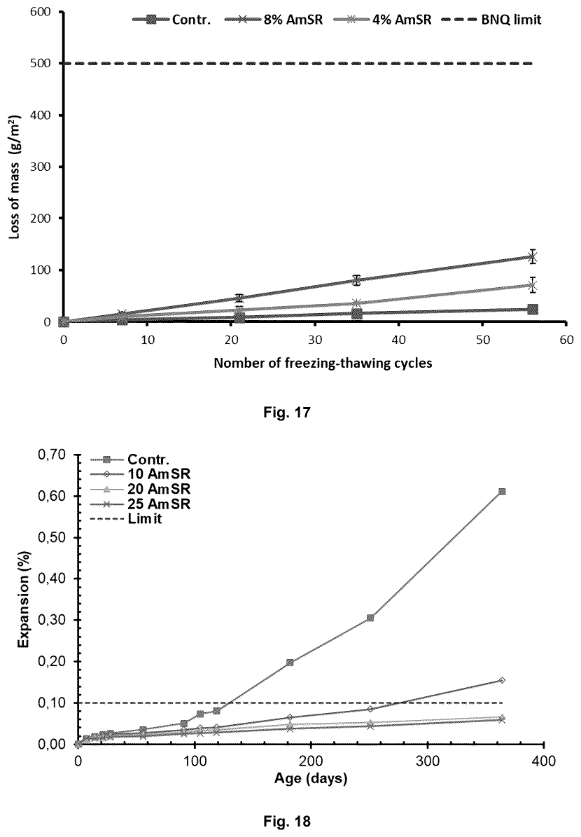

Consistent with what has been described previously, all the concretes studied in this series exhibit very low loss of mass on scaling, illustrating the very good resistance to scaling of these concretes (FIG. 17). These results reflect the good behavior of the material (AmSR) against concrete scaling.

Table 7 shows that all the HPC concretes tested have durability factors very higher than 80% often targeted. These observations suggest that all these concretes exhibit good resistance to freeze-thaw in the absence of melting salts.

TABLE 7
Freezing-thawing resistance

| | Durability factor (%) | | |
|---|---|---|---|
| | Sample | Sample | Average |
| Concrete | #1 | #2 | (%) |
| Contr. | 101 | 99 | 100 |
| 4% AmSR | 99 | 97 | 98 |
| 8% AmSR | 99 | 98 | 99 |

The expansion due to sulfate attack in HPC mixtures incorporating different rate of the amorphous silica residue (AmSR) is reported in FIG. 18. All mixtures incorporating the amorphous silica residue show significantly lower expansions than the control mixture, suggesting a good reduction in expansion in the presence of AmSR. The incorporation of 20% AmSR reduces the expansion of the order of 7 times that of the control. Mixtures containing more than 20% of the AmSR exhibit expansions below the limit recommended by the standard. This observation suggests that the incorporation of more than 20% of the AmSR in cement system helps to control the expansion due to sulfates. The reduction in expansion by AmSR would result on the one hand from the pozzolanic reaction of AmSR which further densifies the cement matrix and on the other hand from the reduction of the hydration products most vulnerable to sulfates.

### Example IV

### Ultra-High Performance Concrete

Ultra-high performance concretes (UHPCs) are actually concretes made from powders and sands whose largest particle is less than 1 mm. The ultra-high performance of these concretes depends not only on the reactivity of these materials but also on the optimization of densification of these concretes (Packing density). Work on UHPCs was carried out with the aim of optimizing the filling of the intergranular voids of the binders in order to have a compact material with good rheological and mechanical performances without any significant change in the demand for water or Superplasticizer.

Since UHPCs are reactive powder concretes, they are composed of HS cement, silica fume, amorphous silica powder, quartz powder, quartz sand, water, and polycarboxylate superplasticizer.

Table 8 shows the formulation of UHPCs tested. AmSR was introduced in the formulation of 4 concretes (from 2.6 to 8.6% of solid which were equivalent of 6.0 to 20% of binder). The water/binder ratio was set at 0.23. It was observed that incorporation of AmSR from 6.0 to −14% approximates the curves of the formulations of the ideal curve of the 1994 Funk and Dinger granular stacking model followed up to 6.0%.

TABLE 8
UHPCs compositions

| AmSR (% of total | UHPC TEM | | UHPC 2.6 | | UHPC 4.3 | | UHPC 6.0 | | BUHPC 8.6 | |
|---|---|---|---|---|---|---|---|---|---|---|
| binder) | 0 | | 6.0 | | 10.0 | | 14.0 | | 20.0 | |
| Materials | kg/m³ | %* | kg/m³ | %* | kg/m³ | %* | kg/m3 | %* | kg/m³ | %* |
| Water | 201.25 | | 201.25 | | 201.25 | | 201.25 | | 210.7113 | 10.4 |
| Silica fume | 175 | 8.6 | 122.5 | 6.0 | 87.5 | 4.3 | 52.5 | 2.6 | 0 | 0.0 |
| Cement | 700 | 34.4 | 700 | 34.4 | 700 | 34.4 | 700 | 34.4 | 700 | 34.4 |
| Quartz powder | 210 | 10.3 | 210 | 10.3 | 210 | 10.3 | 210 | 10.3 | 210 | 10.3 |
| Quartz sand | 950 | 46.7 | 950 | 46.7 | 950 | 46.7 | 950 | 46.7 | 950 | 46.7 |
| AmSR | 0 | 0.0 | 52.5 | 2.6 | 87.5 | 4.3 | 122.5 | 6.0 | 175 | 8.6 |
| Water adjusted | 175 | | 175 | | 175 | | 175 | | 182.8933 | |
| Superplasticizer | 43.75 | | 43.75 | | 43.75 | | 43.75 | | 46.3633 | |
| E/L | 0.23 | | 0.23 | | 0.23 | | 0.23 | | 0.2408 | |
| Super Plastifiant (%/C) | 2.50% | | 2.50% | | 2.50% | | 2.50% | | 2.65% | |

*% of solid portion

The “UHPC 8.6” required a slight readjustment in water and superplasticizer (from 0.23 to 0.2408 E/L and 2.5% to 2.65% solid portion to have the same fresh properties as the reference UHPC).

The compressive strengths, as tested on cubes of 50×50×50 (determined at 7 and 28 days after demolding at 24 hours and normal cure at 20° C. at 100% relative humidity) was almost identical between UHPCs comprising AmSR and control, slightly improved in UHPC with 10% of AmSR. This confirms that the addition of AmSR up to 20% positively affects the early-life performance of UHPCs.

Accordingly, AmSR has a relatively high fineness and a continuous particle size distribution. It rapidly develops compressive strengths, good mechanical properties, maintains permeability and as lower endogenous shrinkage deformities when incorporated in HPC and/or UHPCs.

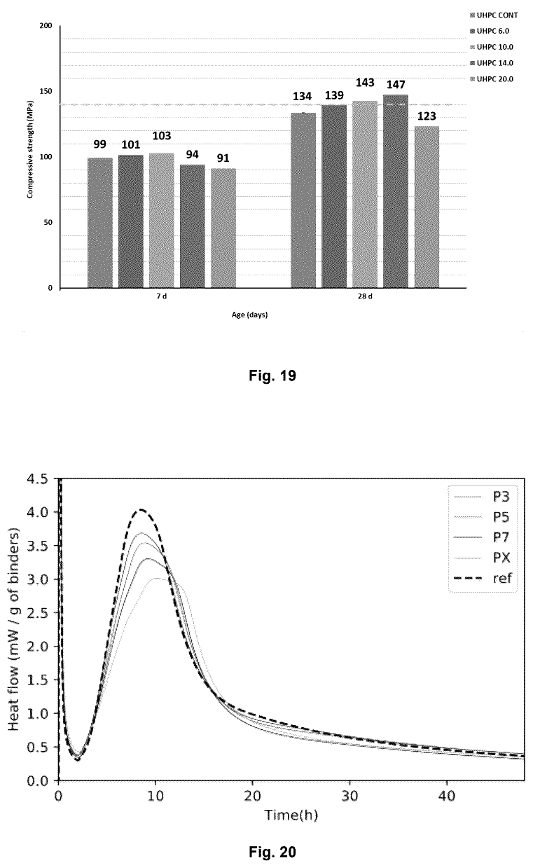

The three concrete compositions in which AmSR is combined with silica fume have a compressive strength at 28 days greater than the compressive strength of the AmSR-free composition. Also, the concrete composition including 20% AmSR has a lower compressive strength than concrete compositions including a mixture of AmSR and silica fume and AmSR-free composition (UHPC Tem), at 28 days, FIG. 19. Again, it therefore advantageous to partially replace the silica fume in HPC for example by AmSR for its advantages in terms of manufacturing cost and availability of AmSR compared to silica fume, in addition to the increase in compressive strength.

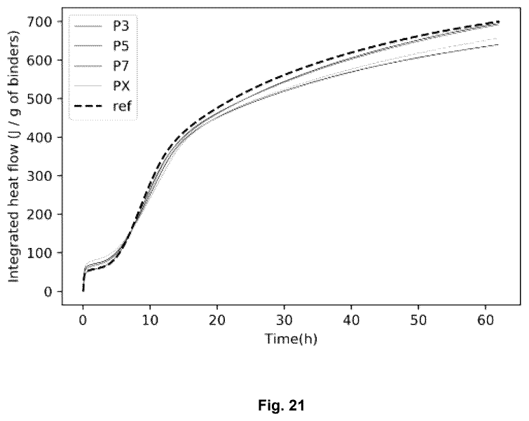

The calorimetry test is another indicator of the synergistic effect between AmSR and smoke from silica. In FIGS. 20 and 21, presented below, the evolution of the heat of hydration and the heat of hydration accumulated at different ratios of silica fume and AmSR is illustrated. These two figures show that the combination “silica fume and AmSP” seems to slightly delay the setting time of the cement (shift to the right of curves). However, this delay is maximized when AmSR is used in complete replacement of silica fume (PX curve). A delay in the hydration of the cement is linked to compressive strengths lower, especially at 28 days, and higher setting times of concrete. So the partial (and not total) replacement of silica fume by AmSP in UHPC is associated with higher compressive strengths and reduced setting times of concrete.

While the present disclosure has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

What is claimed is:

1. A concrete mixture comprising:
a hydraulic binder;
sand;
aggregates;
silica fumes; and
an amorphous silica reagent (AmSR) comprising SiO₂ and active MgO;
and wherein a weight ratio of the silica fumes to the AmSR is from 2.3:1 to 1:2.3,
wherein the concrete mixture has higher compressive strengths and reduced setting times due to the synergistic combination of AmSR and silica fumes compared to a concrete with only AmSR.

2. The concrete mixture of claim 1, wherein said AmSR comprises more than 40% of SiO₂.

3. The concrete mixture of claim 1, wherein said AmSR comprising at least 10% of active MgO.

4. The concrete mixture of claim 1, wherein said AmSR is a serpentine derived AmSR.

5. The concrete mixture of claim 1, comprising Quartz sand.

6. The concrete mixture of claim 1, wherein said hydraulic binder is Portland Cement.

7. The concrete mixture of claim 1, further comprising a high-range water reducer (HRWRA).

8. The concrete mixture of claim 1, wherein said AmSR is produced by:
a) crushing serpentine tailing;
b) leaching the serpentine in an acid solution producing a slurry with undissolved silica comprising a solid and liquid fraction; and
c) separating the solid and liquid fractions of said slurry recuperating the AmSR.

9. The concrete mixture of claim 14, wherein the leaching is conducted at a temperature between 60 to 125° C.

10. The concrete mixture of claim 1, wherein said concrete mixture is a cement mortar, a grout or a self-consolidating concrete (SCC).

11. The concrete mixture of claim 1, wherein said concrete mixture is a CEM type I, II, III, IV or V cement.

12. The concrete mixture of claim 1, wherein said concrete mixture further comprises a superplasticizer, a water reducer agent, an air entrainment agent, or a combination thereof.

13. The concrete mixture of claim 1, wherein concrete said mixture is a high performance concrete (HPC) or a ultra-high performance concrete (UHPC).

14. The concrete mixture of claim 19, wherein said UHPC comprises up to 20% of AmSR.

15. The concrete mixture of claim 20, wherein said HPC comprises:
GU cement;
silica fume (SF);
AmSR;
water;
sand;
aggregates;
an entraining admixture; and
a superplasticizer.

16. The concrete mixture of claim 20, wherein said UHPC comprises:
water;
silica fume;
cement;
quartz powder;
sand; and
AmSR.

17. The concrete mixture of claim 1, comprising:

| | |
|---|---|
| Cement (kg/m³) | 353-415 |
| Silica fume (SF) (kg/m³) | 4-40 |
| AmSR (kg/m³) | 5-45 |
| Water (kg/m³) | 90-175 |
| Sand 0-5 mm (kg/m³) | 558-910 |
| Granulate 5-14 mm (kg/m³) | 1050-1120 |
| Entraining admixture ml/100 kg | 125-300 |
| Superplasticizer (l/m³) | 1.2-4.0. |

18. The concrete mixture of claim 1, comprising:

| | |
|---|---|
| Cement (kg/m³) | 610-1080 |
| Silica fume (SF) (kg/m³) | 50-334 |
| AmSR (kg/m³) | 5-200 |
| Water (kg/m³) | 126-261 |
| quartz powder (kg/m³) | 0-410 |
| quartz sand (kg/m³) | 490-1390 |
| Superplasticizer (kg/m³) | 6-71. |
